(19) United States
(12) Patent Application Publication
(10) Pub. No.: US 2024/0422081 A1
(43) Pub. Date: Dec. 19, 2024

(54) Network Analytics System with Data Loss Detection

(71) Applicant: Telefonaktiebolaget LM Ericsson (publ), Stockholm (SE)

(72) Inventors: Attila Báder, Paty (HU); Gergely Dévai, Budapest (HU)

(21) Appl. No.: 18/702,980

(22) PCT Filed: Nov. 11, 2021
(86) PCT No.: PCT/IB2021/060464

§ 371 Date: Apr. 19, 2024

(51) Int. Cl. H04L 43/04; H04L 41/142; H04L 41/5009

(52) U.S. Cl. CPC H04L 43/04; H04L 41/142; H04L 41/5009

(57) ABSTRACT

A data analytics system for mobile networks includes a data loss detection unit that detects data loss from one or more data sources and estimates the correct sample size of KPIs in a lossless system based on statistical analysis. In case of data loss, the data loss detection unit generates an alarm to a fault manager system and provides detailed loss report to the system administrator, in order to identify the root cause and fix the issue. Additionally, the data loss detection unit estimates of the correct KPI sample sizes for the data sources and sends the correct sample sizes to a data analytics component, where the corrected sample sizes can be taken into account in the affected analytics functions.

### TECHNICAL FIELD

The present disclosure relates generally to network analytics system for analyzing performance of a communication network and, more particularly, to data loss detection in an analytics system for detecting data loss in data received from one or more data sources.

### BACKGROUND

Advanced analytics systems, such as Ericsson Expert Analytics, are based on collecting and correlating elementary network events from multiple data sources in different network domains, such as core, radio and transport networks. Key performance Indicators (KPI)s are calculated based on events from one or more data sources. Service KPIs (S-KPIs) reflect user level and session level end-to-end (E2E) service quality. Radio and network resource KPIs (R-KPIs) characterize the radio environment or network operation at user and session levels. These types of solutions are suitable for session-based troubleshooting and analysis of network issues.

Event-based analytics systems are also used in Service Operation Centers (SOCs) for monitoring the quality of the wide variety of services used in network level, as well as for monitoring the customer experience on individual per subscriber level. These tools are widely used in customer care and other business scenarios.

Event-based analytics requires real-time collection and correlation of characteristic node and protocol events from different radio and core network nodes, probing signaling interfaces (IFs) and sampling of the user-plane traffic as well. In addition to the data collection and correlation functions, the system requires an advanced database, rule engine, and big data analytics platform as well.

With the introduction of Fifth Generation (5G) mobile networks, it is expected that mobile networks will serve (and provide quality of service, quality of experience, etc.) a large variety of new service types as well as to serve much higher number of devices or user equipment (UEs) than mobile networks based on previous network technologies. This diversity will significantly increase the incoming event rate and type to be processed by network analytics systems.

Event based analytics systems collect events from multiple data sources and correlate them into per subscriber data records. The data sources are many times not perfect, there are missing events. In some cases, missing events can be detected based on procedures, e.g., in case of a successful call setup data transmission should follow. Larger amounts of missing data can also be observed by monitoring the daily profile of different events. If there are sudden drop in the rate of one or more event types, it can be concluded that events are lost in the data collection system. Even in these cases, it is not easy to distinguish between data loss due to the data collection system, or data loss due to network or node failure. The detection of node and network failures are an important use case for the analytics system, while data loss in the data collection system is an issue, which prevents proper operation of the analytics system. Moreover, data loss detection methods based on time series analysis cannot be used to verify data collection at the startup of the system.

There are also cases when event loss simply cannot be distinguished from the “no event” case. If the event loss is not large, or full procedures are missing, the analytics system cannot detect loss. In this case, the KPIs based on sample sizes will be incorrect. The exact number of events are crucial information for most of the analytics use cases. Knowing the number of events is therefore very important for KPI normalization, incident ratios, detecting affected number of subscribers, etc.

The data collection system is often a mixture of products from different vendors and the analytics system, in many cases, has no information about data loss. The data collection system do not provide any indication of lost data, and it is near impossible to detect if there is a small amount of permanent or temporary data loss.

Accordingly, new techniques are needed to detect missing events from the data sources and to estimate the real number of events from different data sources and event types in an event-based analytics system.

### SUMMARY

The present disclosure relates to an analytics system for mobile networks based on correlated event data from multiple data sources is described in which a loss detection component is able to detect data loss from one or more data sources and estimate the correct sample size of KPIs in a lossless system based on statistical analysis. The systems and methods herein described are able to distinguish lost data and no activity cases. In case of data loss, a data loss detection unit generates an alarm to a fault manager system and provides detailed loss report to the system administrator, in order to identify the root cause and fix the issue. Additionally, an estimated of the correct KPI sample sizes is sent to a data analytics component, where the corrected sample sizes is taken into account in the affected analytics functions.

A first aspect of the disclosure comprises methods implemented in an analytics system of detecting data loss in data received from one or more data sources. In one embodiment, the method comprises collecting event data associated with a plurality of dimension instances for a dimension of interest from two or more data sources. The method further comprises generating correlated data records for each dimension instance by correlating the event data from the two or more data sources. The method further comprises, for each of one or more dimension instances in the plurality of dimension instances, calculating a first key performance indicator (KPI) based on first KPI samples in the event data received from a first data source in the two or more data sources, and calculating a first KPI ratio between a number of the first KPI samples for the first dimension instance and a number of the correlated data records for the first dimension instance. The method further comprises detecting data loss from the first data source based on the first KPI ratios.

A second aspect of the disclosure comprises an analytics system configured to detect data loss in data received from one or more data sources. In one embodiment, the analytics system is configured to collect event data associated with a plurality of dimension instances for a dimension of interest from two or more data sources. The data analytics system is further configured to generate correlated data records for each dimension instance by correlating the event data from the two or more data sources. The data analytics system is further configured to, for each of one or more dimension instances in the plurality of dimension instances, calculate a first key performance indicator (KPI) based on first KPI samples in the event data received from a first data source in the two or more data sources, and calculate a first KPI ratio between a number of the first KPI samples for the first dimension instance and a number of the correlated data records for the first dimension instance. The data analytics system is further configured to detect data loss from the first data source based on the first KPI ratios.

A third aspect of the disclosure comprises an analytics system configured to detect data loss in data received from one or more data sources. The analytics system comprises communication circuitry for communicating with data sources in a communication network and processing circuitry. In one embodiment, the processing circuitry is configured to collect event data associated with a plurality of dimension instances for a dimension of interest from two or more data sources. The processing circuitry is further configured to generate correlated data records for each dimension instance by correlating the event data from the two or more data sources. The processing circuitry is further configured to, for each of one or more dimension instances in the plurality of dimension instances, calculate a first key performance indicator (KPI) based on first KPI samples in the event data received from a first data source in the two or more data sources, and calculate a first KPI ratio between a number of the first KPI samples for the first dimension instance and a number of the correlated data records for the first dimension instance. The processing circuitry is further configured to detect data loss from the first data source based on the first KPI ratios.

A fourth aspect of the disclosure comprises a computer program for a data analytics system. The computer program comprises executable instructions that, when executed by processing circuitry in the workload scheduler, causes the data analytics system to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

### BRIEF DESCRIPTION OF THE DRAWINGS

FIG. 1 illustrates a mobile communication network with a data analytics system.

FIG. 2 illustrates a data analytics system configured to detect data loss from a data source.

FIG. 3 is a graph of average KPI ratios as a function of the number of subscribers per cell.

FIG. 4 is a graph showing average KPI ratios is a lossless system.

FIG. 5 is a graph showing average KPI ratios is a lossy system.

FIG. 6 is an exemplary method of data loss detection implemented in a data analytics system.

FIG. 7 is another exemplary method of data loss detection implemented in a data analytics system.

FIG. 8 is a block diagram illustrating functional components of a data analytics system with data loss detection.

FIG. 9 is a diagram illustrating a component of the data loss detection system.

### DETAILED DESCRIPTION

The present disclosure relates to an analytics system for mobile networks based on correlated event data from multiple data sources. The analytics system includes a data loss detection component that detects data loss from one or more data sources and estimates the correct sample size of KPIs in a lossless system based on statistical analysis. The data loss detection component detects data loss on data collection interfaces by analyzing statistical properties of subscriber-level analytics data, provided that the data is correlated from at least two independent input interfaces and is partitioned by different dimensions. In case of data loss, the data loss detection component generates an alarm to a fault manager system and provides a detailed loss report to the system administrator in order to identify the root cause and fix the issue. Additionally, an estimate of the correct KPI sample sizes is sent to a data analytics component, where the corrected sample sizes is taken into account in the affected analytics functions.

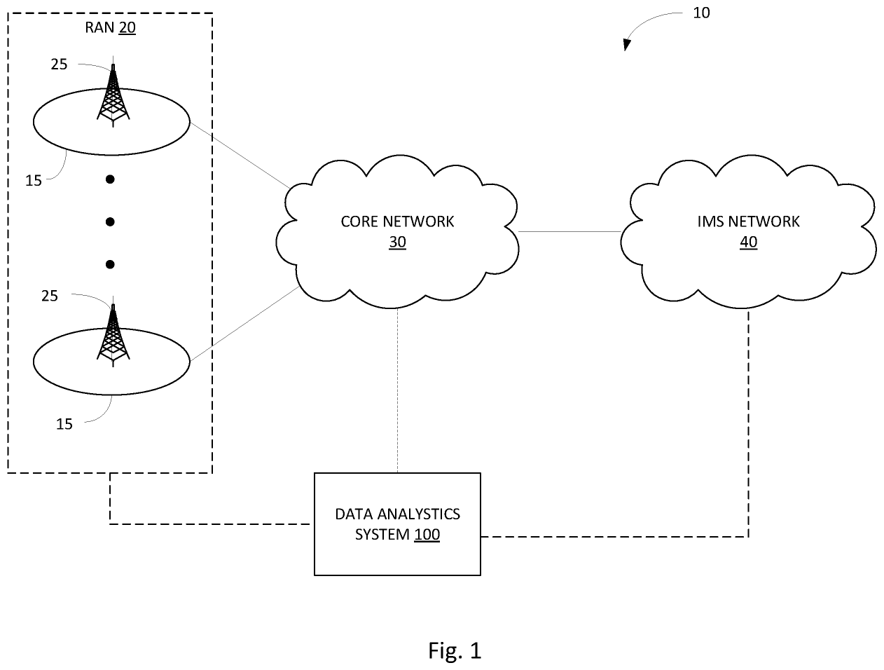

FIG. 1 illustrates a data analytics system 100 for a mobile communication network 10. The mobile communication network 10 generally comprises a radio access network (RAN) (20) a core network (CN) (30) and an Internet Protocol (IP) Multimedia Subsystem (40). The RAN 20 comprises one or more base stations 25, also called access nodes or radio access nodes, providing service to one or more users in respective cells 15 of the mobile communication network. The base stations 25 provide the users with access to the CN 30, which provides a gateway for access to external networks, such as the IMS 40. The data analytics system 100 interfaces with each of the main domains of the mobile communication network 10, collects data a, and provides data analytics for network management.

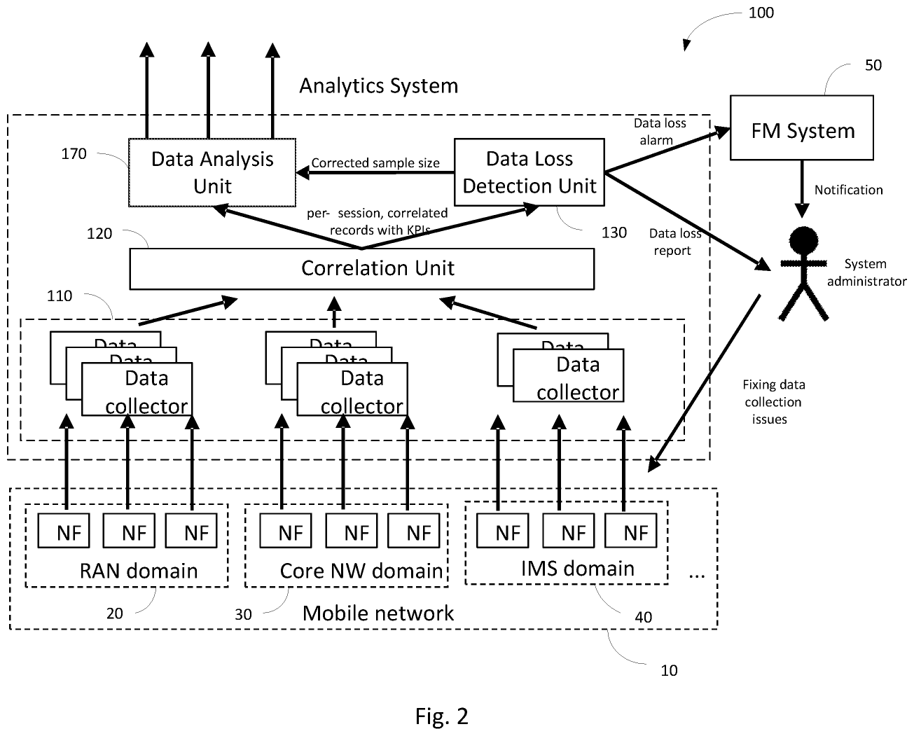

FIG. 2 illustrates an exemplary data analytics system 100 according to an embodiment. The data analytics system 100 generally comprises a data collection unit 110 having a plurality of data collectors, a correlation unit 120, a data analysis unit 170 and a data loss detection unit 130. As used herein, the term unit refers to system comprising one or more computers, microprocessors, digital signal processors, field, programmable gate arrays (FPGSs), application specific integrated circuits (ASICs), cloud servers, other processing hardware, or a combination thereof. A unit can be implemented as a microservice running on a virtual machine (VM), container or bare metal server. A unit can be distributed over multiple host devices. Further, a single host device, e.g., computer, can be configured to function as two or more units of the same type or different type.

The data collectors in the data collection unit 110 receive event data from network functions (NFs) in different domains of a wireless communication network. The NFs are the data sources for the event data. FIG. 2 illustrates data collectors to receive data from NFs the Radio Access Network (RAN) domain, the Core Network (CN) domain and the IMS domain. The data collectors ingest event data from the NFs in the different domains and forward the collected data to the correlation unit 120, which correlates the data from the different data sources and generates end-to-end (E2E) records per session. The correlated data records contain key performance indicators (KPIs) from each of the domains that describe the corresponding session. A correlated data record is generated if the correlation unit 120 receives events related to a session from at least one data source. The data analysis unity 170 and data loss detection unit 130 receive the correlated data records from the correlator. The data analysis unit 170 performs analytic analysis of the data records and makes data analytics available to subscribing NFs.

Certain KPIs are expected to be present in some, but not all, of the data records. The absence of a KPI of interest in a data record received from the correlator may be attributable to user behavior, e.g., a lack of activity during the monitoring period that would produce the KPI. In this case, other KPIs could be present in the data record. In some cases, the absence of a KPI of interest may be attributable to a loss of data from one of the data sources. The data loss detection unit 130 detects if KPIs of interest are missing due to data loss or due to user behavior (no activity). In case of detected data loss, the data loss detection unit 130 sends an alarm to the Fault Management (FM) system 50, which notifies the system administrator. The system administrator can query the data loss detection unit 130 to get more details about the data loss and use the information to troubleshoot and fix the data collection problem. The data loss detection unit 130 also quantifies the data loss and applies a correction to certain aggregated sample sizes (e.g. real number of active subscribers). The data loss detection unit 130 provides corrected sample sizes to the data analysis unit 170. Using these corrected sample sizes in downstream data analysis prevents faulty analytics results.

To understand how data loss is detected, a simple example based on event records from two data sources is described below. Assume that the data analytics system 100 receives events from two independent data sources, denoted respectively as S1 and S2. Per-subscriber correlated records are generated when the data analytics system 100 receives an event from at least one of the data sources. KPI1 is calculated based on an event type from S1 and KPI2 is calculated from another event type from S2.

In the data analytics system 100, KPIs are aggregated for different time periods and dimensions. A dimension is a parameter or variable used for grouping the KPI samples for analysis. Common dimensions used in data analytics include cell, device type, and subscriber type. Thus, the KPI samples can be grouped for analysis based on the associated cell, device type or subscriber type. If a KPI is a ratio, referred to as a ratio-type KPI, small data loss is not an issue because the KPI value is obtained as a sum of KPI values divided by the number of received KPI samples. Small randomly lost events do not influence significantly the value of a ratio-type KPI. However, when the KPI is a number or other quantity, such as a number of call setups, number of bytes, etc., the number of events used for the KPI calculation is important. In this case, data loss can result in significant error in the data analytics.

The probability of receiving a generated event from S1 is denoted p, while the probability of receiving a generated event from S2 is q. The probability that an event is lost is therefore 1−p for S1 and 1−q for S2. If p=1 or q=1, there is no loss at the corresponding data source and the sample sizes of the KPIs are correct.

In a lossless system, the number of correlated data records, Nᵣ, generated by the correlator 30 is given by:

$${N}_{r} = {N}_{1} + {N}_{2} - {N}_{c} , \qquad Eq . ( 1 )$$

where N₁ and N₂ are the number of records generated based on an event from S1 and S2 respectively, and N_{c} is the number of records generated based on an event from both data sources. In a lossy system the number of measured (detected) records are:

$${N}_{r}^{meas} = {N}_{1}^{meas} + {N}_{2}^{meas} - {N}_{c}^{meas} \qquad Eq . ( 2 )$$

The average occurrence of KPI1 and KPI2 in the records, referred to herein as KPI ratios, are denoted by r₁ and r₂ characterize the service usage to which the KPI refers and is independent of the event loss. By definition:

$$r 1 = N 1 / Nr , \qquad Eq . ( 3 )$$

$$and$$

$$r 2 = N 2 / Nr \qquad Eq . ( 4 )$$

In the case of lossy data sources, the actual number of KPI samples for a lossless system can be estimated according to:

$${N}_{1} = {N}_{1}^{meas} / p \qquad Eq . ( 5 )$$

$${N}_{2} = {N}_{2}^{meas} / q \qquad Eq . ( 6 )$$

$${N}_{c} = {N}_{c}^{meas} / pq \qquad Eq . ( 7 )$$

$${N}_{r} = {N}_{1}^{meas} / p + {N}_{2}^{meas} / q - {N}_{c}^{meas} / pq \qquad Eq . ( 8 )$$

In a lossy data collection system 10, Nᵣ^{meas}, N₂^{meas}, and N_{c}^{meas} can be measured or obtained. Therefore, the values of p and q need to be determined in order to estimate Nᵣ, N₁, and N₂ for the analytics use case.

According to one aspect of the disclosure, the measured KPI ratios r₁^{meas}, and r₂^{meas}, for different dimension instances can be used to estimate r₁ and r₂ for a lossless system and to determine the lossy data source. This approach works when there is at least one dimension common to both data sources for which the distribution of loss is uneven. KPI ratios, r₁(i) and r₂(i) are computed for each dimension instance i (e.g., each cell, service type or subscriber type) according to:

$$r ( i ) = {N}_{KPI} ( i ) / {N}_{r} ( i ) \qquad Eq . ( 9 )$$

where N_{KPI}(i) is the number of KPI samples for the dimension instance i and Nᵣ(i) is the number of correlated data records for the same dimension instance. The computed KPI ratios for all the dimension instances are then sorted and ordered according to any measurable parameter, referred to herein as the ordering criteria, which is proportional to the KPI samples on average. The ordering parameter should be independent of the subscriber behavior, namely the service usage, otherwise it may bias the results. The KPI ratios are sorted for different dimension instances into bins based on the ordering criteria and the average KPI ratio is computed per bin for all dimension instances in the bin. For example, where the dimension instance comprises a cell and the ordering criteria is the number of subscribers per cell, the KPI ratios are computed for each cell, i.e. dimension instance. The cells are grouped together into bins based on the number of subscribers in the cell and the average of the KPI ratio is computed for each bin. In this case, a bin can represent a single value of the ordering criteria or a range of values. The computed average KPI values can then be graphed in order by increasing number of subscribers.

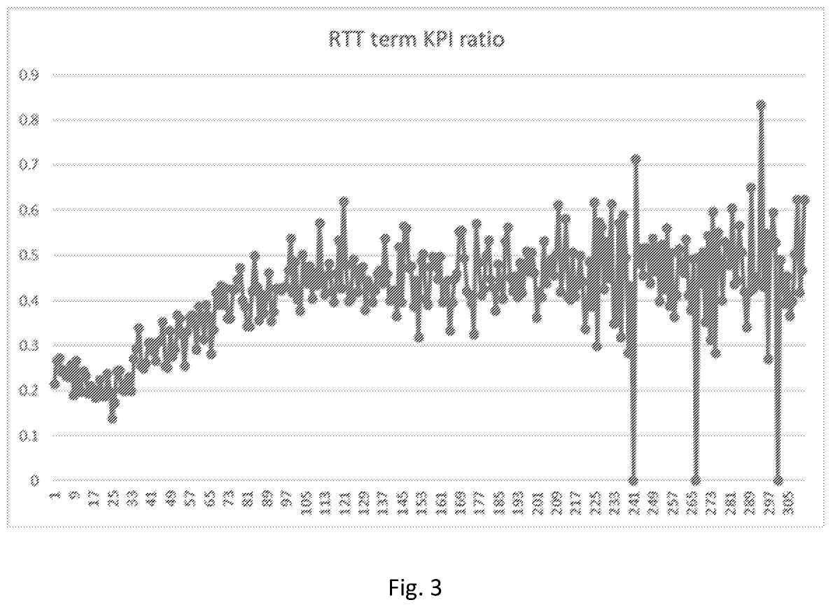

FIG. 3 is an exemplary graph of measured KPI ratios sorted and ordered according to the number of active subscribers per cell. The values along the x axis indicate the number of subscribers in the cell. The y axis indicates the measured KPI ratio. Each data point represents the average KPI ratio for cells with a given number of subscribers. In this example, the KPI is the average round trip time (RTT) for IMS services. The KPI is obtained from GTP probe events. Since the KPI is calculated for specific services, the expected KPI ratio compared to the number of correlated records is about 0.5 in a lossless system. Correlated records are generated either by GTP probe or by IMS events (or both). In this example, data at the GTP probe was lost. As a result, some of the sessions with no IMS activity are not visible to the data analytics system 100, which makes the affected cells seem to serve less subscribers. In those seemingly small cells, the ratio of IMS KPIs are measured higher than the real value (not depicted on this chart) while the ratio of the GTP-probe-based KPIs are smaller (see the left third of the graph). If the loss probability would be even for each cell, or there is no loss, the ratio should be approximately the same for cells with low and high number of active subscribers.

Although the KPI values and number of samples can be different for different sample bins (e.g. cell), the measured KPI ratio comparing the number of KPI samples to the number of correlated data records depends primarily on p and q as follows:

$$\begin{matrix}{r}_{1}^{meas} = {N}_{1}^{meas} / {N}_{r}^{meas} \\ = N 1 * p / ( N 1 * p + N 2 * q - Nc * p * q ) \\ = 1 / ( 1 + N 2 * q / N 1 * p - Nc * q / N 1\end{matrix} \qquad Eq . ( 10 )$$

$${r}_{2}^{meas} = {N}_{2}^{meas} / {N}_{r}^{meas} = 1 / ( 1 + N 1 * p / N 2 * q - Nc * p / N 1 ) \qquad Eq . ( 11 )$$

If p=1 and q=1, then r₁^{meas}=r₁ and r₂^{meas}=r₂.

The dimension instances are ordered by any measurable parameter which is proportional to the KPI samples in average, e.g. the number of simultaneously active subscribers per dimension instance. This ordering parameter should be independent of the subscriber behavior, namely the service usage, otherwise it may bias the results. FIG. 3 shows one example of such ordering based on number of active subscribers per cell. In the case of a lossless system, the average KPI ratio remains relatively constant regardless of the number of subscribers. But in case of data loss in one of the sources, the average KPI ratio value is uneven.

The graph of average KPI ratios and the records for the different dimension instances are used for detecting loss at a data source. The measured KPI ratios for dimension instances with a large number of subscribers will typically be close to the actual KPI ratio, while the measured KPI ratios for dimension instances with few subscribers will tend to vary in the event of data loss. If p and q are 1, i.e. no loss, the distribution of KPI values will be flat. If case of data loss, the values of the KPI ratio is uneven. This pattern is indicative of data loss from the data source. Thus, a significant difference between the lowest and highest 10% values of r₁^{meas} and r₂^{meas} is a good indication that there is data loss from the corresponding data source. The actual KPI ratios r₁ and r₂ can be determined by taking the asymptotic values of the above ratio, i.e. the plateau values. In this way r₁ and r₂ can be determined using the measured data in the lossy system. Alternatively, the r1/r2 ratio should be monitored and if there the difference of r1/r2 ratio is significant between the low and high sample range, it indicates data loss in the corresponding event source, see the simulation results.

If there are many measurement values for different dimension instances, the dimension instances with a large number of samples will characterize the lossless system. The KPI ratios r₁ and r₂ can be determined by taking the plateau values of the above plotted KPI ratio. In this way r₁ and r₂ are determined using the measured data in the lossy system. In the example shown in FIG. 3, the distribution of KPI ratios gradually increases in cells with less than about 97 subscribers and then flattens.

Once r₁ and r₂ are determined, it is possible to estimate the actual loss probability for the data sources. In embodiments of the present disclosure, p and q are expressed as a function of the KPI ratios r₁ and r₂, where r₁ is the ratio of KPI1 samples to the number of correlated data records, and r₂ is the ratio of KPI2 samples to the number of correlated data records. Thus,

$${r}_{1} = {N}_{1} / {N}_{r} = ( {N}_{1}^{meas} / p ) / ( {N}_{1}^{meas} / p + {N}_{2}^{meas} / q - {N}_{c}^{meas} / pq ) , \qquad Eq . ( 12 )$$

$$and$$

$${r}_{2} = {N}_{2} / {N}_{r} = ( {N}_{2}^{meas} / q ) / ( {N}_{1}^{meas} / p + {N}_{2}^{meas} / q - {N}_{c}^{meas} / pq ) \qquad Eq . ( 13 )$$

$${N}_{c}^{meas} = {N}_{1}^{meas} + {N}_{2}^{meas} - {N}_{r}^{meas} \qquad Eq . ( 14 )$$

In Eqs. (12) and (13), the values of rd, r₂, N₁^{meas}, N₂^{meas}, and N_{c}^{meas} are known or can be determined as described above so the values of p and q can be calculated from Eqs. (12)-(14). If p and q are calculated for each dimension instance, e.g. for each cell, the distribution of p and q are obtained. Using these distributions, the average and other quantiles of p and q can be determined. N₁, N₂ and Nᵣ can then be estimated using equations (5)-(8) using the computed values of p and q.

In a lossless system, Nᵣ^{meas}, will be equal to Nᵣ. Data loss is indicated when Nᵣ^{meas} is less than Nᵣ. Thus, comparison of the measured number of correlated records, Nᵣ^{meas}, computed according to Eq. (2) to the estimated number of records, Nᵣ, computed according to Eq. (6) will indicate the extent of data loss, but the comparison does not provide any information about where the loss occurs, i.e., which data source is lossy.

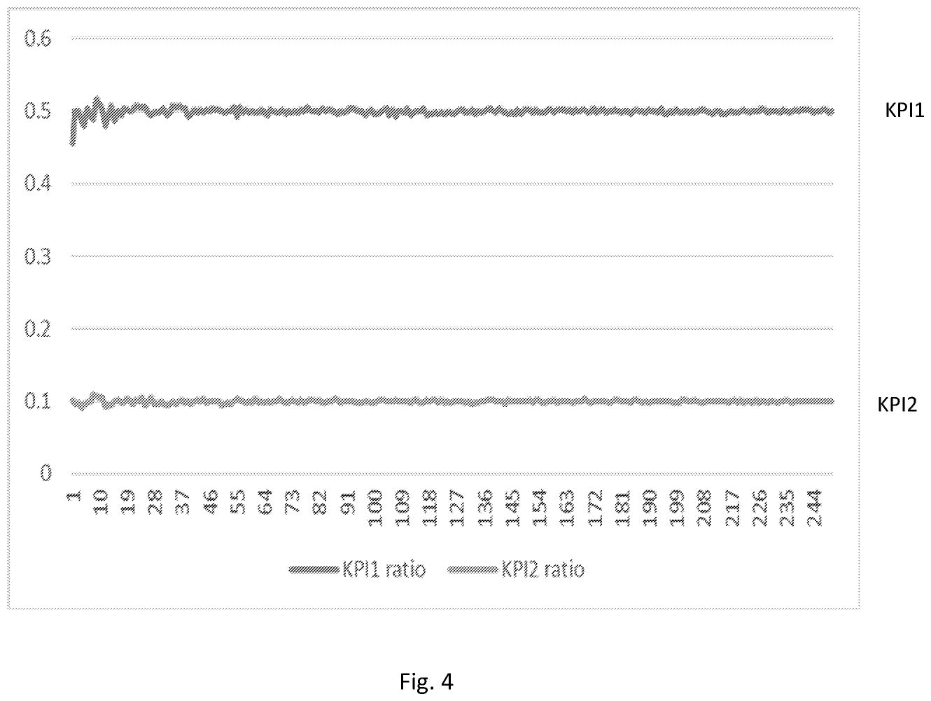

A simulation was performed to validate the use of the KPI ratio distribution to detect data loss. FIG. 4 is a graph of KPI values in a lossless system. The x axis shows the number of active subscribers per cell as seen by the data analytics system 100. The y axis shows the ratio of active subscribers with the selected KPI (compared to all active subscribers). That is, independently of how many subscribers are active in a cell, about half of the subscribers have KPI1 and only 10% of them have KPI2. This is because KPI1 and KPI2 correspond to certain traffic types that not all active subscribers produce all the time, e.g., mobile broadband traffic and voice over Long Term Evolution (VoLTE) calls.

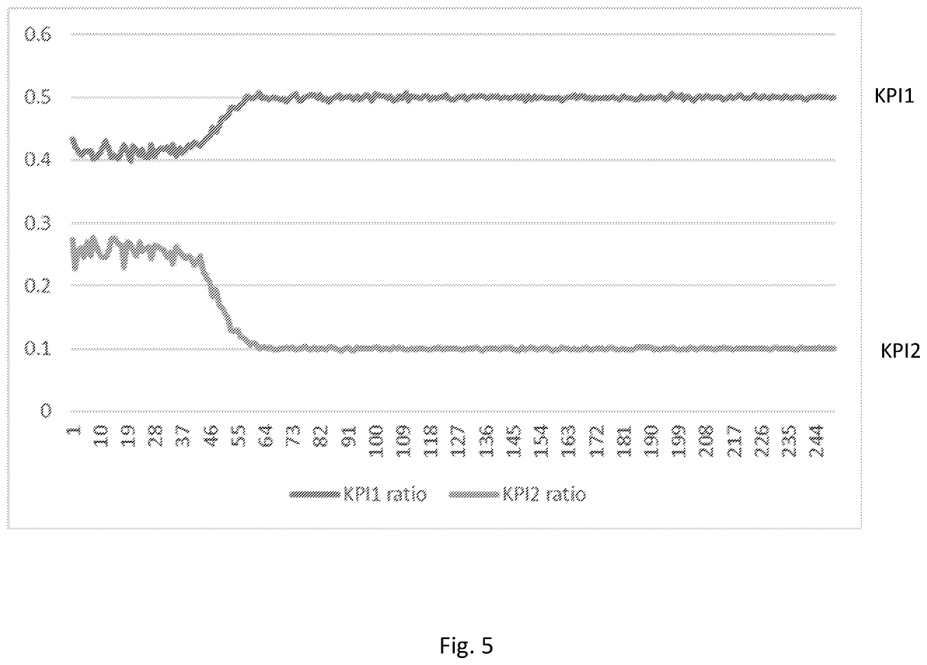

FIG. 5 shows the graph with the same settings, except that the data analytics system 100 loses 90% of the traffic of the interface corresponding to KPI1 in 10% of the cells. This example represents a considerable amount of data loss, which is only used to make the phenomena easy to spot in the graph, but the technique is also able to detect smaller losses as well.

In FIG. 4, there is a sharp step up in case of KPI1 (the lossy one) and a step down in the KPI2 graph (which had full data). The reason for this distortion is as follows. In a problematic (lossy) cell with average number of active subscribers, most of the subscribers only produce data on the interface corresponding to KPI1, but we lose a considerable part of this data. Therefore, these subscribers are not visible to the data analytics system 100, and the cell seems to be much less populated than it is in reality. Furthermore, this seemingly small cell has an unusually large number of KPI2 instances and a lower number of KPI1 instances because the cells producing KPI2 are visible but only a fraction of those that produced KPI1 are visible. As a result, the KPI ratios are distorted for the cells with lower number of active subscribers, and converge to the real KPI ratio values in the more populated cells.

When data loss is detected, the data loss detection unit 130 generates a data loss report and sends it to the system administrator. the data loss report contains the KPI ratio values for different dimensions and sample bins, and the estimated data loss probability of the different data sources. Based on the data loss report, the affected KPIs and the data sources can be identified. Based on the dimension for which KPIs are affected, the root cause can may be identified. For example, if the dimension is cell, the data loss is area coverage related. If it is terminal type, the data loss is probably device related. If it is network function, then it is probably related to a NF or node failure

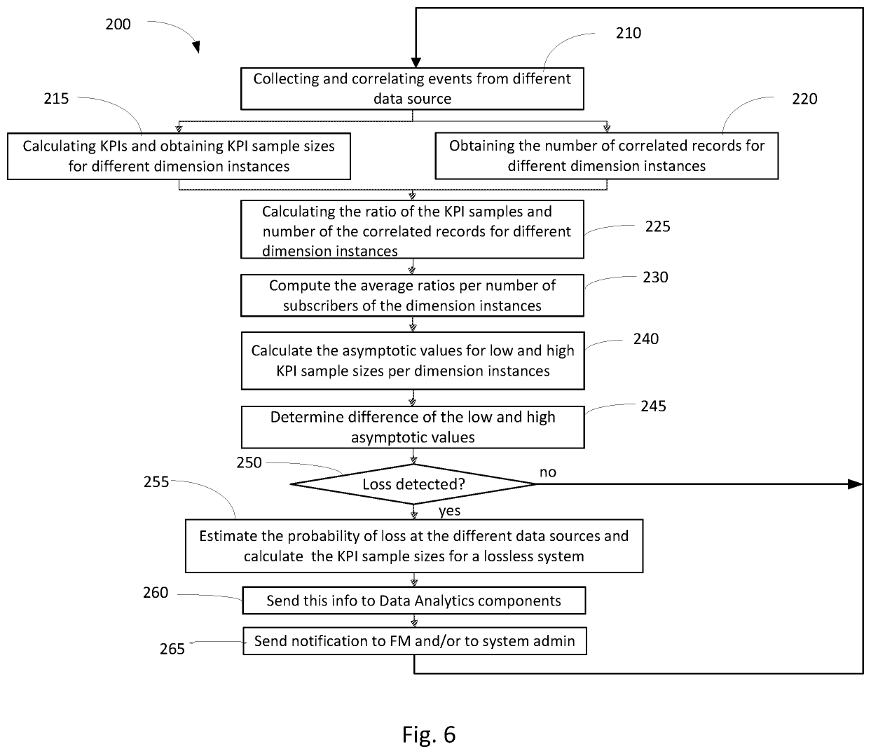

FIG. 6 illustrates an exemplary method 200 of detecting data loss in a data analytics system 100 according to an embodiment. The data analytics system 100 collects and correlates events from different data sources using any known techniques (210). KPIs are calculated and KPI samples are determined for different dimension instances (e.g., cells, device types, subscriber types, etc.)(215). Also, the number of correlated data records for the different dimension instances is determined or obtained (220). The data loss detection unit 130 calculates the ratio of KPI samples and number of correlated records for the different dimension instances (225). The data loss detection unit 130 then calculates the average KPI ratios for the different subsets of the dimension instances grouped based on the ordering criteria and orders the average KPI ratios according to an ordering criteria, such as number of subscribers per cell (230). The data loss detection unit 130 calculates the high and low asymptotic values of the ordered KPI ratios and determines the difference (240, 245). The difference is compared to a threshold to determine if there is data loss (250). If data loss is detected, the data loss detection unit 130 estimates the probability of data loss at the different data sources and calculates a corrected KPI sample size based on the calculated probabilities (255). The data loss detection unit 130 sends the corrected KPI sample size to the data analytics unit 130 for use in computing analytics (260). The data loss detection unit 130 also sends a data loss report to the fault manager and/or system administrator (265).

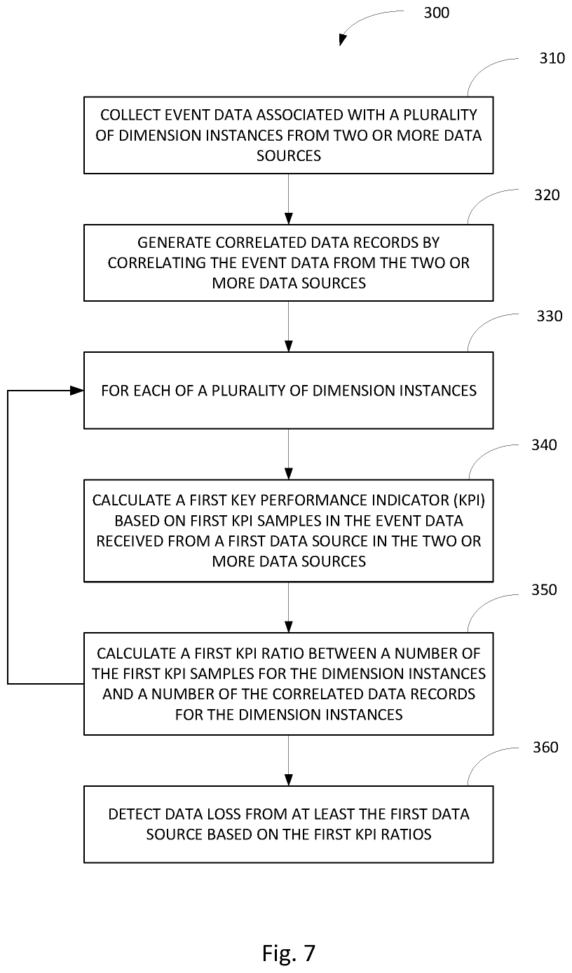

FIG. 7 illustrates an exemplary method 300 data loss detection performed by a data analytics system 100. The data analytics system 100 collects event data associated with a plurality of dimension instances for a dimension of interest from two or more data sources (310) and generates correlated data records for each dimension instance by correlating the event data from the two or more data sources (320). For each of one or more dimension instances in the plurality of dimension instances (330), the data analytics system 100 calculates a first key performance indicator (KPI) based on first KPI samples in the event data received from a first data source in the two or more data sources (340) and calculates a first KPI ratio between a number of the first KPI samples for the first dimension instances and a number of the correlated data records for the first dimension instances (350). The method further comprises detecting data loss from the first source based on the first KPI ratios (360).

Some embodiments of the method 300 further comprise, for each of one or more dimension instances in the plurality of second dimension instances, calculating a second aggregate key performance indicator (KPI) based on second KPI samples in the event data received from a second data source in the two or more data sources, calculating a second KPI ratio between a number of the second KPI samples for the second dimension instance and a number of the correlated data records for the second dimension instance, and detecting data loss from the second source based on the second KPI ratios.

In some embodiments of the method 300, calculating the first and second KPI ratios comprises, for each dimension instance, determining first and second event probabilities, corresponding respectively to a probability of a first KPI sample occurring in the event data from the first data source and a probability of a second KPI sample occurring in the event data from the second data source, and calculating the first and second ratios based on the first and second event probabilities.

In some embodiments of the method 300, determining the first and second event probabilities is based on a first relation of the first ratio to the first and second event probabilities and a second relation of the second ratio to the first and second event probabilities.

In some embodiments of the method 300, detecting data loss from at least one of the first and second data sources based on the first and second ratios comprises grouping and sorting the first KPI ratios according to an ordering criteria, computing average KPI values for one or more groups of the KPI ratios for the first data source, calculating a low asymptotic value and a high asymptotic value from the average KPI ratio for the first data sources, and detecting data loss from the first data source based on a comparison of the low asymptotic value and the high asymptotic value.

In some embodiments of the method 300, detecting data loss from the first data source based on a comparison of the low asymptotic value and the high asymptotic value comprises detecting data loss by comparing a difference between the low asymptotic value and the high asymptotic value to a threshold.

In some embodiments of the method 300, detecting data loss from at least one of the first and second data sources based on the first and second ratios further comprises sorting and ordering the second KPI ratios according to an ordering criteria, computing average KPI values for one or more groups of the KPI ratios for the second data source, calculating a low asymptotic value and a high asymptotic value from the average KPI ratios for the second data source, and detecting data loss from the second data source based on a comparison of the low asymptotic value and the high asymptotic values.

In some embodiments of the method 300, detecting data loss from the second data source based on a comparison of the low asymptotic value and the high asymptotic value for the second data source comprises detecting data loss by comparing a difference between the low asymptotic value and the high asymptotic value to a threshold.

In some embodiments of the method 300, detecting data loss from at least one of the first and second data sources based on the first and second ratios comprises: detecting data loss from the first and/or second data sources based on a comparison of one or more first KPI ratios and one or more corresponding second KPI ratios.

Some embodiments of the method 300 further comprise estimating a loss probability for the first data source and/or the second data source.

Some embodiments of the method 300 further comprise calculating an estimated KPI sample size for the first data source and/or second data source based on the respective loss probabilities.

Some embodiments of the method 300 further comprise sending the estimated KPI sample size for the first data source and/or the second data source to an analytics component.

Some embodiments of the method 300 further comprise sending a data loss notification to a management system responsive to the detection of a data loss from at least one of the first and second data sources.

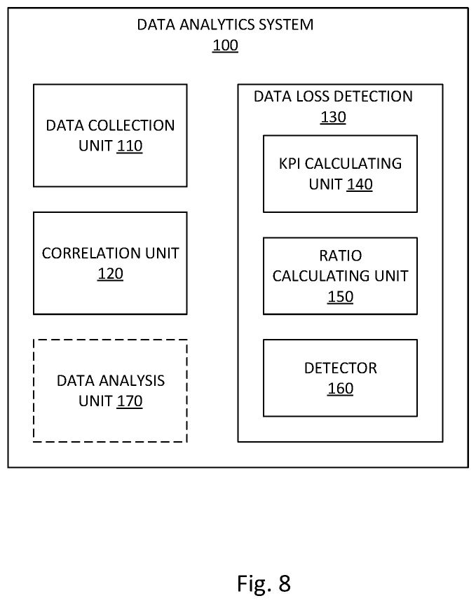

FIG. 8 illustrates the functional components of a data analytics system 100. For convenience, reference numerals introduced in FIG. 1 are used to indicate similar components. The data analytics system 100 comprises a data collection unit 110, a correlation unit 120, a data loss detection unit 130 and a data analysis unit 170. The data loss detection unit 130 further comprises a KPI calculating unit 140, a ratio calculating unit 150 and a detector 160. The various units 110-170 can be implemented by hardware and/or by software code that is executed by one or more processors or processing circuits. Further, each of the units 110-170 can be implemented as microservices running on a virtual machine, container, or on bare metal. The data collection unit 110 is configured to collect event data associated with a plurality of dimension instances for a dimension of interest from two or more data sources. The correlation unit 120 is configured to generate correlated data records for each dimension instance by correlating the event data from the two or more data sources. The data loss detection unit 130 is configured to detect data losses. The KPI calculating unit 140 is configured to calculate a first key performance indicator (KPI) based on first KPI samples in the event data received from a first data source in the two or more data sources. The ratio calculating unit 150 is configured to calculate a first KPI ratio between a number of the first KPI samples for the first dimension instances and a number of the correlated data records for the first dimension instances. The detector 160 is configured to detect data loss from the first source based on the first KPI ratios.

In some embodiments, the KPI calculating unit 140 is further configured to calculate a second key performance indicator (KPI) based on second KPI samples in the event data received from a second data source in the two or more data sources, and the ratio calculating unit 150 is further configured to calculate a second KPI ratio between a number of the second KPI samples for the second dimension instances and a number of the correlated data records for the second dimension instances. The detector 160 is configured to detect data loss from second source based on the second KPI ratios.

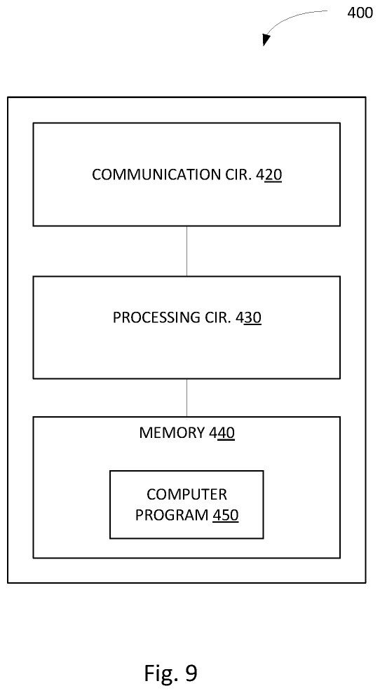

FIG. 9 illustrates an exemplary data analytics component 400 of the data analytics system 100. The data analytics component 400 generally comprises communication circuitry 420 for communicating with network devices over a communication network, processing circuitry 430 for controlling the operation of the data analytics component 400 and memory 440 for storing programs and data needed by the data analytics component.

The communication circuitry 420 couples the data analytics component 400 to a communication network for communication with other network devices to manage cloud resources in the cloud RAN 100 and to receiving scheduling requests from network operators. The communication circuitry 420 may comprise a wired or wireless interface operating according to any standard, such as the Ethernet, Wireless Fidelity (WiFi) and Synchronous Optical Networking (SONET) standards.

The processing circuitry 430 controls the overall operation of the data analytics component 400. The processing circuitry 430 may comprise one or more microprocessors, hardware, firmware, or a combination thereof. The processing circuitry 430 is configured to perform the functions of the data analytics component as herein described. For example, the data analytics component 100 can be configured as a data collection unit 110, a correlation unit 120, or a data loss detection component 130, or a combination of such units.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores computer program 450 comprising executable instructions that configure the processing circuitry 430 to implement the methods herein described. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1-19. (canceled)

20. A method implemented in an analytics system of detecting data loss in data received from one or more data sources, the method comprising:
collecting event data associated with a plurality of dimension instances for a dimension of interest from two or more data sources;
generating correlated data records for each dimension instance by correlating the event data from the two or more data sources;
for each of one or more dimension instances in the plurality of dimension instances:
calculating a first key performance indicator (KPI) based on first KPI samples in the event data received from a first data source in the two or more data sources;
calculating a first KPI ratio between a number of the first KPI samples for the first dimension instances and a number of the correlated data records for the first dimension instances;
detecting data loss from the first source based on the first KPI ratios.

21. The method of claim 20, further comprising:
for each of one or more dimension instances in the plurality of second dimension instances:
calculating a second aggregate key performance indicator (KPI) based on second KPI samples in the event data received from a second data source in the two or more data sources;
calculating a second KPI ratio between a number of the second KPI samples for the second dimension instance and a number of the correlated data records for the second dimension instance and
detecting data loss from the second source based on the second KPI ratios.

22. The method of claim 21, wherein calculating the first and second KPI ratios comprises, for each dimension instance:
determining first and second event probabilities, corresponding respectively to a probability of a first KPI sample occurring in the event data from the first data source and a probability of a second KPI sample occurring in the event data from the second data source; and
calculating the first and second ratios based on the first and second event probabilities.

23. The method of claim 22, wherein determining the first and second event probabilities is based on a first relation of the first ratio to the first and second event probabilities and a second relation of the second ratio to the first and second event probabilities.

24. The method of claim 20, wherein detecting data loss from at least one of the first and second data sources based on the first and second ratios comprises:
grouping and sorting the first KPI ratios according to an ordering criteria;
computing average KPI values for one or more groups of the KPI ratios for the first data source;
calculating a low asymptotic value and a high asymptotic value from the average KPI ratio for the first data sources; and
detecting data loss from the first data source based on a comparison of the low asymptotic value and the high asymptotic value.

25. The method of claim 24, wherein detecting data loss from the first data source based on a comparison of the low asymptotic value and the high asymptotic value comprises detecting data loss by comparing a difference between the low asymptotic value and the high asymptotic value to a threshold.

26. The method of claim 24, wherein detecting data loss from at least one of the first and second data sources based on the first and second ratios further comprises:
sorting and ordering the second KPI ratios according to an ordering criteria;
computing average KPI values for one or more groups of the KPI ratios for the second data source;
calculating a low asymptotic value and a high asymptotic value from the average KPI ratios for the second data source; and
detecting data loss from the second data source based on a comparison of the low asymptotic value and the high asymptotic values.

27. The method of claim 26, wherein detecting data loss from the second data source based on a comparison of the low asymptotic value and the high asymptotic value for the second data source comprises detecting data loss by comparing a difference between the low asymptotic value and the high asymptotic value to a threshold.

28. The method of 20, wherein detecting data loss from at least one of the first and second data sources based on the first and second ratios comprises:
detecting data loss from the first and/or second data sources based on a comparison of one or more first KPI ratios and one or more corresponding second KPI ratios.

29. The method of 20, further comprising estimating a loss probability for the first data source and/or the second data source.

30. The method of claim 29, further comprising calculating an estimated KPI sample size for the first data source and/or second data source based on the respective loss probabilities.

31. The method of claim 29 further comprising sending the estimated KPI sample size for the first data source and/or the second data source to an analytics component.

32. The method of claim 20, further comprising sending a data loss notification to a management system responsive to the detection of a data loss from at least one of the first and second data sources.

33. A data analytics system for network performance monitoring, the network analytics system being comprising:
communication circuitry for communicating with other network nodes in a wireless communication network; and
processing circuitry configured to:
collect event data associated with a plurality of dimension instances for a dimension of interest from two or more data sources;
generate correlated data records for each dimension instance by correlating the event data from the two or more data sources;
for each of one or more dimension instances in the plurality of dimension instances:
calculate a first key performance indicator (KPI) based on first KPI samples in the event data received from a first data source in the two or more data sources;
calculate a first KPI ratio between a number of the first KPI samples for the first dimension instances and a number of the correlated data records for the first dimension instances;
detect data loss from the first source based on the first KPI ratios.

34. The data analytics system of claim 33, further comprising:
for each of one or more dimension instances in the plurality of second dimension instances:
calculating a second aggregate key performance indicator (KPI) based on second KPI samples in the event data received from a second data source in the two or more data sources;
calculating a second KPI ratio between a number of the second KPI samples for the second dimension instance and a number of the correlated data records for the second dimension instance and
detecting data loss from the second source based on the second KPI ratios.

35. The data analytics system of claim 34, wherein the processing circuitry is further configured to calculate the first and second KPI ratios by, for each dimension instance:
determining first and second event probabilities, corresponding respectively to a probability of a first KPI sample occurring in the event data from the first data source and a probability of a second KPI sample occurring in the event data from the second data source; and
calculating the first and second ratios based on the first and second event probabilities.

36. The data analytics system of claim 33, wherein the processing circuitry is further configured to detect data loss from at least one of the first and second data sources based on the first and second ratios by:
grouping and sorting the first KPI ratios according to an ordering criteria;
computing average KPI values for one or more groups of the KPI ratios for the first data source;
calculating a low asymptotic value and a high asymptotic value from the average KPI ratio for the first data sources; and
detecting data loss from the first data source based on a comparison of the low asymptotic value and the high asymptotic value.

37. The data analytics system of claim 33, wherein the processing circuitry is further configured to detect data loss from at least one of the first and second data sources based on the first and second ratios comprises:
detecting data loss from the first and/or second data sources based on a comparison of one or more first KPI ratios and one or more corresponding second KPI ratios.

38. The data analytics system of claim 33, wherein the processing circuitry is further configured to estimate the loss probability for the first data source and/or the second data source.

39. The data analytics system of claim 33, wherein the processing circuitry is further configured to send a data loss notification to a management system responsive to the detection of a data loss from at least one of the first and second data sources.
